(19) United States
(12) Patent Application Publication
(10) Pub. No.: US 2009/0295178 A1
(43) Pub. Date: Dec. 3, 2009

(54) ROTORHOOK

(75) Inventor: Thomas Paul Corcoran, Farmington, MO (US)

Correspondence Address: Thomas P. Corcoran, 3668 Williams Road, Farmington, MO, 63640, US

(73) Assignee: Thomas Paul Corcoran, Farmington, MO (US)

(21) Appl. No.: 12/156,424

(22) Filed: Jun. 2, 2008

(51) Int. Cl. B66C 1/34

(52) U.S. Cl. 294/82.15

(57) ABSTRACT

This pivoting hook system is designed to give the operator or the spotter on the building control over the swing of material being lifted. It provides a safer distance from under the load, as workers are in potential danger at times when handling tether ropes attached to beams, trusses, etc. as they guide them into place. This device provides a safer alternative to tying a rope to loads for positioning.

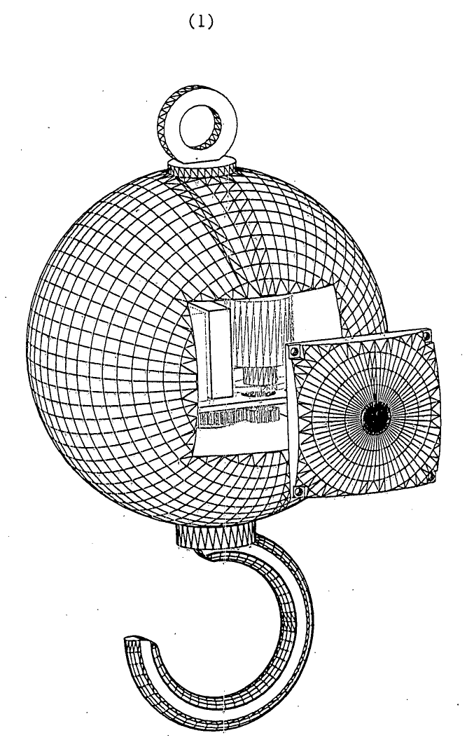

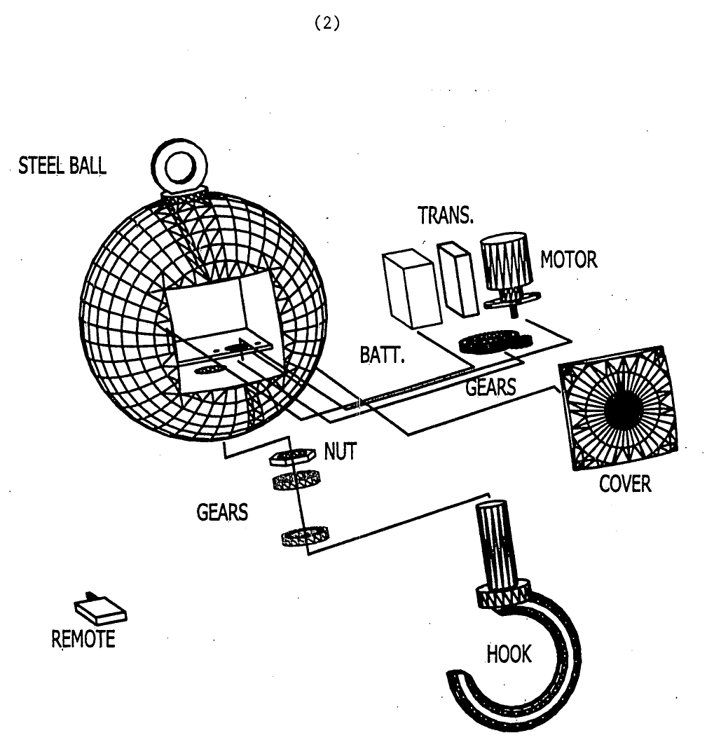

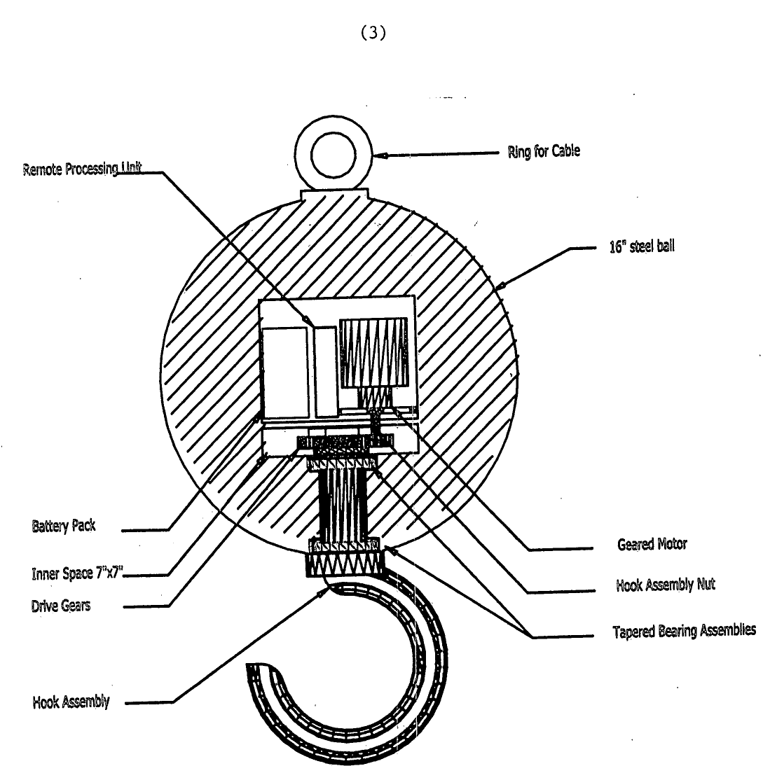

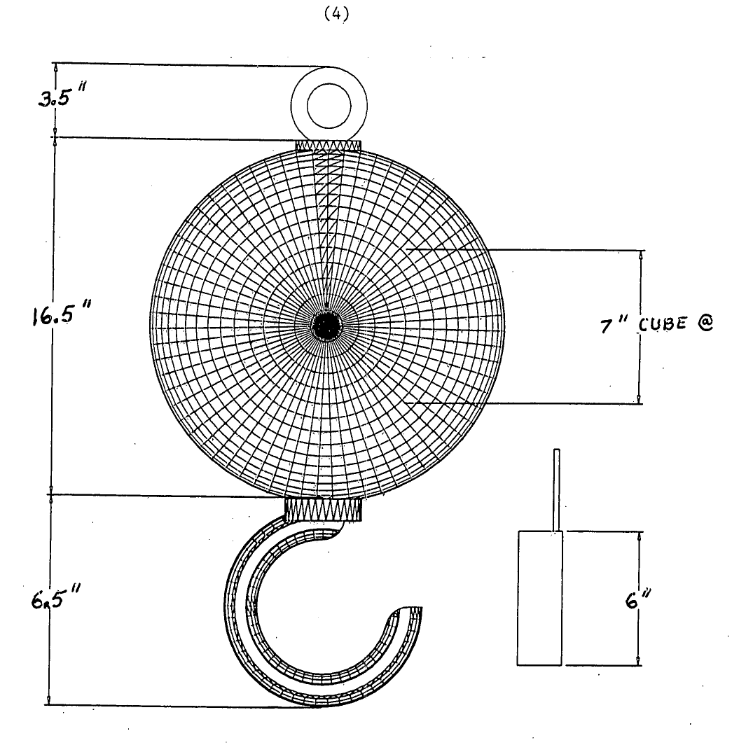

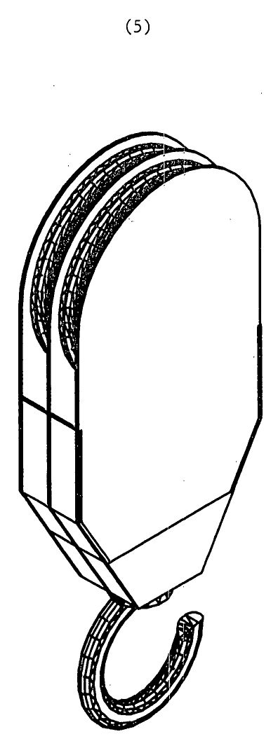

### BACKGROUND OF THE INVENTION

This pivoting hook system is designed to give the operator or the spotter, on the building or site of delivery, the ability to turn the load into the proper position. This is done with the use of a hand held remote control, using a wireless frequency (IR or RF) that communicates with the wireless operating system within the “ROTORHOOK” Assembly.

The crux of the invention is to give the operator the ability to turn the object being lifted, e.g., truss, steel beams, equipment, without the use of tether ropes. (a rope tied to the load for the purpose of turning it into the proper position while still in the air.)

### BRIEF SUMMARY OF THE INVENTION

This procedure will create a much safer working environment for the worker. The turning process is done through the use of a gear drive system, using a servo motor for the drive portion within the assembly. By remote operation this crane cable attachment provides a hook system in which to lift loads by the operator without the normal danger of turning it with ropes. Letting the operator turn the load as it is lifted into place. The speed and direction the load is turned is managed by the remote operator.

Drawing #1 is of an isometric view of the described 15 ton assembly, it depicts the cover separated from the body of the invention by a few inches. This exposes the inside mechanism that turns the hook protruding below the ball assembly. Drawing #2 is an exploded view showing individual parts with lines showing the order in which they go into the inner space of the assembly. Drawing #3 is a front view section drawing, it shows the 16 inch ball cut in half, exposing the inner mechanism of the assembly. Drawing #4 is of a rear view of the ball assembly. Drawing #5 is an example of an alternate version of “ROTORHOOK” used for multi-cable block type cranes. The same operating system used to turn hook.

### DETAILED DESCRIPTION OF THE INVENTION

To manufacture this invention as drawn, you need only to cast a steel ball sixteen inches in diameter with the following recesses subtracted from the inside of the ball: A centered seven inch cube of space, in addition one side of the cube protrudes what would be chosen as the front side of the ball, a two inch hole protruding the bottom/center of the cube of space countersunk one half inch by three inch from center of hole at each end. After this steel ball is cast, a three quarter inch thick hardened steel ring is welded to the top center of the ball. (A double ring can be used with a pin as an alternative for attachment to crane cable)

The two recesses at either end of the hole through the bottom of the sphere are for two sets of tapered bearings to be installed opposing each other with the smaller diameters of bearings facing each other. The hook portion of the assembly (1½″ girth by 1″ thickness, 3″ interior radius 270° leaving 90° opening and forming hook) is made in one piece with the two inch hardened shaft with three inch diameter collar that is just above the hook, shaft being seven inches long beyond the three quarter inch thick backup collar. The Shaft portion is fine threaded for the last one inch.

The shaft is slipped through the two bearing/race lubricated assemblies, leaving two and a half inches of the shaft protruding the bottom of the inside cube of space. A four and one half inch diameter by three quarter inch thick main gear fitted with a quarter inch key and key way on shaft slips onto shaft after a three quarter inch by two inch inside diameter by one quarter inch girth sleeve. (spacer between bearing and gear) Once sleeve and gear is on shaft a hex nut fits on the end of shaft, held in place by a locking ring fitted between the nut and gear.

When tightened together; the bearings pressed toward each other and locked in place, the hook turns easily, providing a secure system in which to lift prescribed loads.

Two and three quarter inch above the floor of inside space is a one quarter inch thick steel plate. This plate is welded in place and supports the one quarter horsepower servo electric drive motor. The drive motor has a two inch shaft by three eighth diameter. The servo motor is mounted inversely, having a one and one half inch drive gear fastened to mesh with main gear. The servo motor is powered by a rechargeable battery and controlled through a wireless operating system sharing the same platform.

The wireless receiver bolted next to the Servo motor on the internal platform works in conjunction with the remote control use by the operator. The rechargeable battery bolted down to the platform next to the receiver on the same platform is recharged with a recessed hookup on the exterior of the ball. When in operation, each night the operator can plug it in for recharging. The square hole in the front of the ball has a cover with four quarter inch bolt holes and bolts to fasten to the ball. This cover has the same contour as the rest of the ball and when attached it forms the full sphere. The bolts fasten into four triangles with holes welded in each corner far enough inside the square hole to make this possible.

This device will allow the operator to push a button on the left side of the remote to turn the hook counterclockwise or a button on the right face side of the remote to turn the hook in a clockwise direction. A sliding bar in the center will allow the operator to adjust the speed of turn as to compensate for stop and start, to prevent overrun of desired position of load being set into place.

1. The 16″ ball size “Rotorhook” depicted here is rated for 15 tons. The weight of the assembly is around five hundred pounds.

2. Additional sizes will be made in relation to desired lifting capacity, the larger the capacity, the bigger the mechanism.

3. Alternate configurations of housing are determined by crane type and size. Cranes with multiple cables use a pulley type housing to allow for whatever number of cables necessary.

4. Turning mechanism remains in similar configuration, only enlarged or reduced in size to meet capacity needs.

5. Smaller versions can be made in square or other shapes to reduce bulk and weight, keeping same turning mechanism.

6. Since the operating system includes a servo motor and electronic control, a computer aided control can be added to pre position material on an XYZ directional grid pattern.

7. Electronics can be added to X-Ray cargo for security at ports, etc.

8. Uses for “Rotorhook” will include: Cranes on offshore oil rigs and all types of crane configurations needing the load rotated into position.

9. Rotorhook provides the first ever remote controlled turning apparatus to be attached at the end of crane cables to lift and turn loads by the crane and operator without the use of ropes.

10. Turning the loads can be done by either the operator of the crane or by the worker at the load delivery site.

11. The Rotorhook assembly can have sensors added to detect radioactive materials presence in loads being lifted, thereby adding to security.
